(19) United States
(12) Patent Application Publication
(10) Pub. No.: US 2014/0107992 A1
(43) Pub. Date: Apr. 17, 2014

(54) DISTRIBUTOR OF NEURONS IN A NEOCORTICAL COLUMN

(71) Applicant: Ecole Polytechnique Federale De Lausanne (EPFL), (US)

(72) Inventors: Georges Khazen, Zouk Mikael - Keserwan (LB); Henry Markram, Lausanne (CH); Felix Schürmann, Lausanne (CH); Martin Telefont, Renens (CH)

(73) Assignee: ECOLE POLYTECHNIQUE FEDERALE DE LAUSANNE (EPFL), Lausanne (CH)

(21) Appl. No.: 13/796,193

(22) Filed: Mar. 12, 2013

Related U.S. Application Data
(60) Provisional application No. 61/712,942, filed on Oct. 12, 2012.

(51) Int. Cl. G06F 19/00

(52) U.S. Cl. CPC G06F 19/3437
USPC 703/11

(57) ABSTRACT

Computer-implemented methods, software, and systems for determining a distribution of neuronal cells across a portion of a brain are described. One computer-implemented method for determining a target distribution of one or more neuronal cells across a portion of a brain, comprising: constraining, by one or more computers, a start distribution of the one or more neuronal cells by expression of one or more marker genes and by protein stain of the one or more marker genes across the portion of the brain to obtain the target distribution.

### CROSS-REFERENCE TO RELATED APPLICATION

This application claims the benefit of U.S. Provisional Application Ser. No. 61/712,942, filed on Oct. 12, 2012, which is incorporated by reference.

### TECHNICAL FIELD

The present disclosure relates to computer-implemented methods, software, and systems for determining a distribution of neuronal cells across a portion of a brain.

### BACKGROUND

A multitude of experiments over the past century have yielded insights into cellular and synaptic organization of the microcircuitry of the neocortex and to its possible role as a functional unit—a column of six layers of cells. The available data is, however, highly fragmented and often conflicting. More importantly, the gaps in our knowledge of neocortical column are so large that it may require an impractical number of experiments to fill all of them. The set of different types of neurons that make up a brain is referred to as neurome, which may be a crucial component for a reconstruction of a neocortical column.

### SUMMARY

The present disclosure describes one or more aspects, implementations and embodiments involving devices, systems and methods for determining a distribution of neuronal cells across a portion of a brain. A difficulty arises from the fact that there is a large number of morphological, electrical, morpho-electrical, pharmacological and genetic cell types, and from the fact that genes expressions may fluctuate spontaneously thus making a systematic characterization challenging. For example, the proportion of the different morpho-electrical combinations across the six layers may remain enigmatic. The set of different types of neurons that make up a brain is referred to as neurome, which may be a crucial component for a reconstruction of a neocortical column. Consequently, a methodology that would allow identifying the distribution of the different proportions across the neocortical layers is highly needed.

One or more of the following aspects of this disclosure can be implemented or embodied alone or in combination as methods that include the corresponding operations. One or more of the following aspects of this disclosure can be implemented or embodied alone or in combination in a system comprising a processor that is configured to perform operations according to the one or more of the following aspects. One or more of the following aspects of this disclosure can be implemented or embodied alone or in combination on a computer-readable medium having instructions stored thereon that, when executed by a processor, cause the processor to perform operations according to the one or more of the following aspects.

In aspect 1, a computer-implemented method for determining a target distribution of one or more neuronal cells across a portion of a brain comprises: constraining, by one or more computers, a start distribution of the one or more neuronal cells by expression of one or more marker genes and by protein stain of the one or more marker genes across the portion of the brain to obtain the target distribution.

Aspect 2 according to aspect 1, further comprising: outputting the target distribution, wherein the target distribution shows a lower deviation of the expression of the one or more marker genes from the protein stain of the corresponding marker gene than the start distribution.

Aspect 3 according to any one of aspects 1 to 2, wherein the constraining comprises: generating, in a first step, the start distribution of the one or more neuronal cells based on a predetermined number of neuronal cells for the portion of the brain.

Aspect 4 according to aspect 3, assigning, in a second step following the first step, one or more genetic sequences to the one or more neuronal cells, wherein at least one of the one or more sequences includes at least one of the one or more marker genes.

Aspect 5 according to aspect 4, comparing, in a third step following the second step, the protein stain of the one or more marker genes across the portion of the brain with the start distribution.

Aspect 6 according to aspect 5, further comprising: repeating, in a fourth step, the second and the third step a given number of times while computing, for each time of the given number of times, the deviation, wherein the target distribution is determined using a distribution of the one or more neuronal cells across the portion of the brain that shows the lowest of the computed deviations.

Aspect 7 according to any one of aspects 4 to 6, further comprising: mapping the one or more genetic sequences to one or more cell types, wherein the target distribution represents a distribution of the one or more cell types across the portion of the brain, and wherein the cell types may be at least one of morphological cell types, electrical cell types and pharmacological cell types.

In aspect 8, a system for determining a target distribution of one or more neuronal cells across a portion of a brain, comprising a processor that is configured to execute the following operations: constraining a start distribution of the one or more neuronal cells by expression of one or more marker genes and by protein stain of the one or more marker genes across the portion of the brain to obtain the target distribution.

Aspect 9 according to aspect 8, wherein the processor is further configured to execute the following operations: outputting the target distribution, wherein the target distribution shows a lower deviation of the expression of the one or more marker genes from the protein stain of the corresponding marker gene than the start distribution.

Aspect 10 according to any one of aspects 8 to 9, further comprising: generating, in a first step, the start distribution of the one or more neuronal cells based on a predetermined number of neuronal cells for the portion of the brain.

Aspect 11 according to aspect 10, further comprising: assigning, in a second step following the first step, one or more genetic sequences to the one or more neuronal cells, wherein at least one of the one or more sequences include at least one of the one or more marker genes.

Aspect 12 according to aspect 11, further comprising: comparing, in a third step following the second step, the protein stain of the one or more marker genes across the portion of the brain with the start distribution.

Aspect 13 according to aspect 12, repeating, in a fourth step, the second and the third step a given number of times while computing, for each time of the given number of times, the deviation, wherein the target distribution is determined using a distribution of the one or more neuronal cells across the portion of the brain that shows the lowest of the computed deviations.

Aspect 14 according to any one of aspects 11 to 13, further comprising: mapping the one or more genetic sequences to one or more cell types, wherein the target distribution represents a distribution of the one or more cell types across the portion of the brain, and wherein the cell types may be at least one of morphological cell types, electrical cell types and pharmacological cell types.

In aspect 15, a computer-readable medium having computer-executable instructions stored thereon that, when executed by a processor, cause the processor to perform a method for determining a target distribution of one or more neuronal cells across a portion of a brain, comprising: constraining a start distribution of the one or more neuronal cells by expression of one or more marker genes and by protein stain of the one or more marker genes across the portion of the brain to obtain the target distribution.

Aspect 16 according to aspect 15, further comprising: outputting the target distribution, wherein the target distribution shows a lower deviation of the expression of the one or more marker genes from the protein stain of the corresponding marker gene than the start distribution.

Aspect 17 according to any one of aspects 15 to 16, wherein the constraining comprises: generating, in a first step, the start distribution of the one or more neuronal cells based on a predetermined number of neuronal cells for the portion of the brain.

Aspect 18 according to aspect 17, assigning, in a second step following the first step, one or more genetic sequences to the one or more neuronal cells, wherein at least one of the one or more genetic sequences include at least one of the one or more marker genes.

Aspect 19 according to aspect 18, comparing, in a third step following the second step, the protein stain of the one or more marker genes across the portion of the brain with the start distribution.

Aspect 20 according to aspect 19, further comprising: repeating, in a fourth step, the second and the third step a given number of times while computing, for each time of the given number of times, the deviation, wherein the target distribution is determined using a distribution of the one or more neuronal cells across the portion of the brain that shows the lowest of the computed deviations.

Aspect 21 according to any one of aspects 18 to 20, further comprising: mapping the one or more genetic sequences to one or more cell types, wherein the target distribution represents a distribution of the one or more cell types across the portion of the brain, and wherein the cell types may be at least one of morphological cell types, electrical cell types and pharmacological cell types.

In aspect 22, a system for determining a target distribution of one or more neuronal cells across a portion of a brain, comprising a processor that is configured to execute the following operations: generating a start distribution of the one or more neuronal cells; constraining a start distribution of the one or more neuronal cells by expression of one or more marker genes and by protein stain of the one or more marker genes across the portion of the brain to obtain the target distribution, wherein the constraining comprises: assigning one or more genetic sequences to the one or more neuronal cells, wherein at least one of the one or more sequences include at least one of the one or more marker genes; and mapping the one or more genetic sequences to one or more cell types (e.g., the cell types may be at least one of morphological cell types, electrical cell types and pharmacological cell types); and outputting the target distribution, wherein the target distribution shows a lower deviation of the expression of the one or more marker genes from the protein stain of the corresponding marker gene than the start distribution.

Aspect 23 according to any one of aspects 1 to 22, wherein the one or more neuronal cells comprise at least one inhibitory neuronal cell and at least one excitatory neuronal cell, and wherein the start distribution is generated based on a predetermined ratio of a number of the inhibitory neuronal cell to a number of the excitatory neuronal cell across the portion of the brain, wherein the ratio is used to distribute the inhibitory neuronal cell in the portion of the brain while ensuring the ratio, and wherein the marker genes are markers for the inhibitory neuronal cell.

Aspect 24 according to any one of aspects 1 to 23, wherein the target distribution is outputted by comparing the target distribution with a given distribution and outputting an average of the target distribution and the given distribution.

Aspect 25 according to any one of aspects 1 to 24, wherein the target distribution shows a higher fitness in an optimization algorithm compared to the start distribution, wherein the optimization algorithm is at least one of evolutionary algorithm, genetic algorithm, simulated annealing algorithm and swarm optimization algorithm.

Aspect 26 according to aspect 25, wherein the fitness is computed by calculating a difference or the deviation between an expression percentage of each of the marker genes in the portion of the brain and an expression percentage of each of the protein in the portion of the brain.

Aspect 27 according to any one of aspects 7, 14, 21 and 22 to 26, wherein a subset of the one or more genetic sequences includes members that each uniquely map to one of the cell types.

Aspect 28 according to any one of aspects 1 to 27, wherein the protein is an antibody.

Aspect 29 according to any one of aspects 1 to 28, wherein the portion of the brain comprises one or more subsets, optionally comprises six subsets.

Aspect 30 according to any one of aspects 1 to 29, wherein the one or more marker genes are between 1 and about 100 marker genes, optionally are between 1 and 10 marker genes, optionally are about seven marker genes.

Aspect 31 according to any one of aspects 4 to 7, 11 to 14 and 18 to 30, wherein the determining of the target distribution comprises: determining a distribution of the one or more genetic sequences of the one or more neuronal cells across the portion of the brain that converges towards the protein stain of the one or more marker genes across the portion of the brain.

Aspect 32 according to any one of aspects 1 to 31, wherein the portion of the brain is a neocortical column of the brain and/or wherein the portion of the brain comprises one or more layers, optionally comprises six layers of the neocortical column of the brain.

Aspect 33 according to any one of aspects 1 to 32, wherein the one or more neuronal cells optionally are between 1 and 10¹² neuronal cells, optionally are about 10¹¹ neuronal cells, optionally are between 1 and 10⁹ neuronal cells, optionally are about 10⁸ neuronal cells, optionally are about 10⁶ neuronal cells, optionally are between 1 and 10⁵ neuronal cells, optionally are about 30,000 neuronal cells.

Aspect 34 according to any one of aspects 1 to 33, wherein the marker genes are markers for the neuronal cells.

The subject-matter described in this specification can be implemented in particular implementations or embodiments so as to realize one or more of the following advantages.

First, a computer-implemented model determining a distribution of neuronal cells across a portion of a brain (e.g., one or more layers of a neocortical column of the brain) is provided that may allow to mimic the composition of an actual neocortical column. This may help to find sources of neural diseases and may contribute to implementations of in-silico experiments, e.g. for identifying potential ways for treatment of the neural diseases.

Second, a neurome of a neocortical column is derived and modeled informatically. This may allow computer developers to learn from neuronal circuits of a brain to improve semiconductor-based processors, e.g. to reduce power consumption of computers and/or increase the speed of data processing.

Third, the model may allow implementing neuronal circuit designs in neuromorphic circuits.

Fourth, a computer-implemented model of a neurome is provided that may allow for ease of integration of upcoming experimental data that may render the model more diverse and/or more accurate.

Fifth, the resulting target distribution of neuronal cells may be used for artificial neural networks, e.g. for classification tasks or artificial intelligence.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 illustrates an exemplary neuronal network at a high level.

FIG. 2 illustrates exemplary ratios of inhibitory to excitatory neuronal cells across layers of a neocortical column.

FIG. 3 illustrates exemplary computer-implemented model for deriving a neurome.

FIG. 4 illustrates exemplary genetic sequences that are mapped to an exemplary number of mapped morphological cell types.

FIG. 5 illustrates an exemplary fitness improvement in a genetic algorithm.

FIG. 6 illustrates exemplary target distribution of neuronal cells across layers of a neocortical column.

FIG. 7 illustrates an exemplary back-mapping of genetic sequences to morphological cell types.

FIG. 8 illustrates an exemplary averaging of a target distribution and an estimated distribution.

Reference numbers and designations in the various drawings indicate exemplary aspects, implementations or embodiments of particular features of the present disclosure.

### DETAILED DESCRIPTION

The disclosure generally describes computer-implemented methods, software, and systems for determining a distribution of neuronal cells across a portion of a brain (e.g., across a neocortical column of the brain).

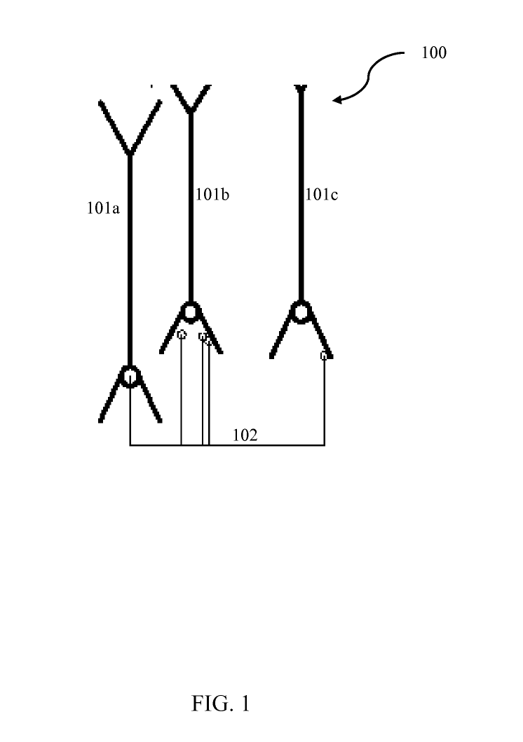

FIG. 1 illustrates an exemplary neuronal network (100) at a high level. For example, a neuronal circuit (e.g., a microcircuit), may comprise two or more neuronal cells (101a-c) which are connected by one or more connections (102) in between the cells (101a-c). For example, 55 morphological types of neuronal cells in a neocortical column may render 3025 potentially synaptic connections (e.g., synaptic pathways). Only a few of these synaptic connections have been systematically characterized and some of them may remain uncharacterized. To accelerate deriving a distribution of neuronal cells across layers of the neocortical column, a computer-implemented model of a neurome is described herein. In general, most neurons (101a-c) in the column are structurally (e.g., via physical touch) in contact with most of other neuronal cells (101a-c). For the purpose of this disclosure, the term “neuronal cell” may relate to artificial cells of a computer-based model. The “neuronal cells” may be configured to act to some degree like biological neuronal cells (e.g. neurons) from an actual portion of an actual biological brain of a human or an animal. For the purpose of this disclosure, the term “portion” of a brain may refer to, e.g., a subset of the brain, a volumetric fraction of the brain, the entire brain, a neocortical column of the brain or a subset of the neocortical column of the brain.

The neurome refers to the set of different types of neurons that make up the brain and may therefore be a critical component in the reconstruction of a neocortical column. Determining the neurome may be a challenge not only because of the uncertainties in classifying the cell type, e.g. the morphological or electrical types of a neuron, but especially because of their potentially much greater molecular diversity. For example about 2500 neurons may be used as a base for an estimated cellular composition. However, obtaining the composition in this manner may not be feasible for other brain regions of the whole brain because of enormous number of experiments required to comprehensively sample all required cell types. Therefore, there is a demand for an algorithmic method to derive the neurome that can be employed for various regions of a brain of various subjects.

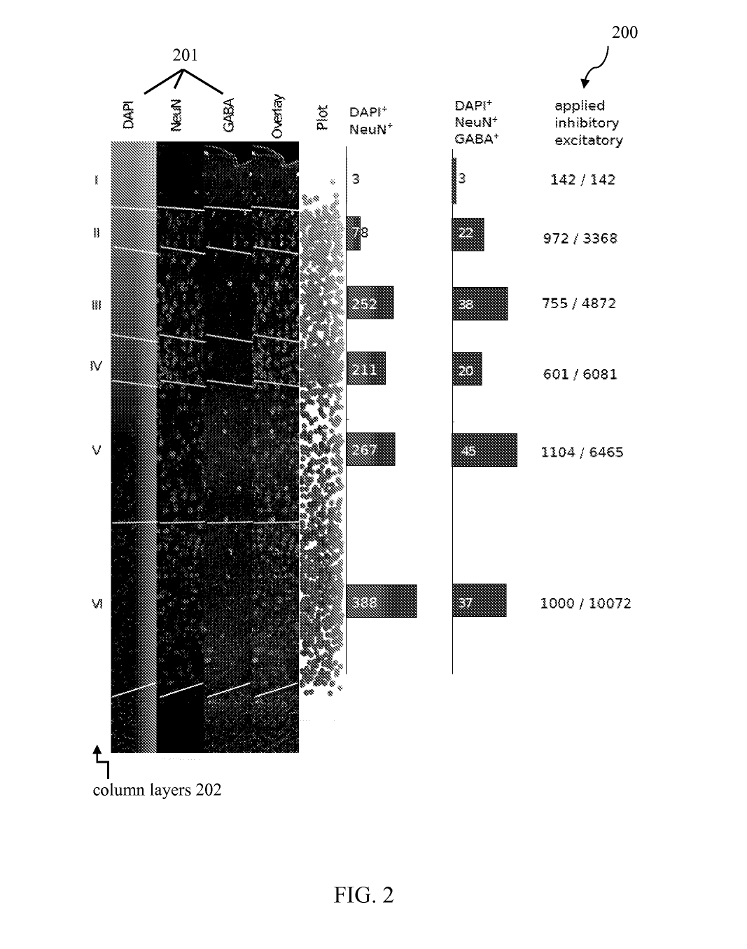

FIG. 2 illustrates ratios (200) of inhibitory to excitatory neuronal cells across the one or more, in this example six, layers (202) of a, in this example juvenile rat, neocortical column. Typically, cells that release the neurotransmitter glutamate, so-called glutamatergic cells are referred to as excitatory. Similarly, cells that release the neurotransmitter GABA, so-called GABA-ergic cells are referred to as inhibitory. In an aspect, the step described in this disclosure of determining a ratio between inhibitory and excitatory cells may be applied to another criterion of differentiation of cells.

Excitatory neuronal cells may be morphologically classified into pyramidal neuronal cells (PC), star pyramidal neuronal cells (SP), bipolar pyramidal neuronal cells (BPC) or spiny stellate neuronal cells (SS). For example, pyramidal neuronal cells may exhibit a thick apical dendrite which ends in a tuft, star pyramidal neuronal cells may exhibit a slender apical dendrite that ends without a tuft, and spiny stellate neuronal cells may have an apical dendrite which may mostly be indistinguishable from their basal dendrites.

Inhibitory cells in the neocortical column have diverse somatic, dendrite and/or axonal morphologies. Dendritic morphology in these neurons may particularly vary, and thus may not solely be used for classification as in excitatory neuronal cells. For example, in order to classify these cells, axonal arborization patterns and/or targets may be used in addition. Inhibitory neuronal cells may, for example, be classified in one or more of the following morphologic cell types: dense axon neurogliaform cell (NGC-DA), sparse axon neurogliaform cell (NGC-SA), horizontal axon cell (HAC), HACs with descending axon collaterals (DAC), dense local axon arborizing cell (DLAC), sparse local axon arborizing cell (SLAC), bipolar cells (BP), bitufted cells (BTC), chandelier cells (ChC), double bouquet cells (DBC), large basket cells (LBC), small basket cells (SBC), nest basket cells (NBC), Martinotti cells (MC), neurogliaform cells (NGC) and further morphologic cell types. Electrical cell types may be classified according to the Petilla convention.

For the computer-implemented model for determining a distribution of neuronal cells across layers of a neocortical column (i.e. deriving the neurome), a number and/or distribution of each of the, e.g. 207, morpho-electrical types of cells in each of the layers of the column is determined in a manner consistent with cellular and molecular properties of the neocortical column (e.g., neocortex). For example, one may determine a total neuron density in each layer. This may be performed, e.g., by counting every fluorescently labeled cell in a 3-dimensional volume of the neocortical column across its, e.g. six, layers. For example, a number of excitatory and inhibitory neuronal cells may be obtained from stained slices (201) of the column, e.g. the slices may be stained by protein (e.g., antibody) stains such as NeuN, DAPI, GABA+ and/or GABA−. For instance, the NeuN stained slice may be used to obtain the number of neuronal cells across the cortical column, while the GABA+ and/or GABA− stained slices may be used to obtain the ratio of inhibitory to excitatory neuronal cells across the portion of the brain. For example, the ratio may be obtained in order to constrain the absolute number of excitatory and inhibitory neuronal cells in the column. For instance, confocal microscopy may be used to scan a portion of the column and integrate the scans into a single image stack.

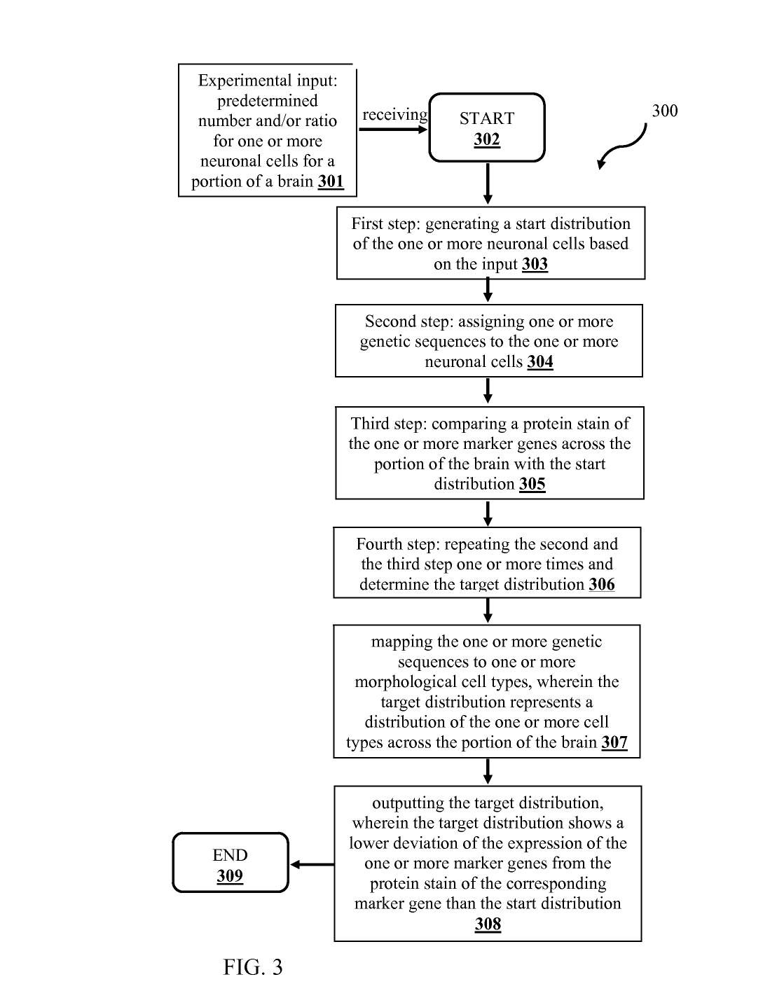

The height (y-direction, vertical) of the column shown in FIG. 2 may be normalized to a scale of 0 to 1, where 0 corresponds to the bottom of layer VI and 1 corresponds to the top of layer I. Each of the distributed neuronal cells may have a relative y-coordinate (between 0 and 1). The x-coordinate (horizontal) may be neglected at this stage. In an aspect, the ratio (200) of inhibitory to excitatory neuronal cells for each of the one or more layers of the cortical column, as determined, e.g., in context of FIG. 2, may be used, e.g. in the model described in context of FIG. 3, to (e.g., randomly) distribute inhibitory neuronal cells while ensuring a consistent proportion with the excitatory neuronal cells in the portion of the brain (e.g. one or more layers of the neocortical column of the brain).

FIG. 3 illustrates exemplary computer-implemented method or model (300) for deriving a neurome. In a general aspect of the subject-matter described herein, a computer-implemented method (300) for determining a target distribution of one or more neuronal cells across a portion of a brain comprises: constraining a start distribution of the one or more neuronal cells across the portion of the brain by expression of one or more marker genes and by protein stain of the one or more marker genes across the portion of the brain to obtain the target distribution. One or more of the following aspects may be implemented in combination with one or more general aspects described in context of FIG. 3. In an aspect, the model may comprise: generating, in a first step (303), the start distribution of the one or more neuronal cells based on experimental input (301), e.g. the input may be received before the start (302) of the method (300). The input may include, e.g., a predetermined number of neuronal cells for the portion of the brain (e.g., each of the one or more layers of the neocortical column of the brain) and/or a predetermined ratio of inhibitory to excitatory neuronal cells. The neuronal cells may comprise at least one inhibitory neuronal cell and at least one excitatory neuronal cell. In an aspect, the one or more neuronal cells comprise at least one inhibitory neuronal cell and at least one excitatory neuronal cell, and wherein the start distribution is generated based on a predetermined ratio (e.g., as a part of the experimental input (301)) of a number of the inhibitory neuronal cell to a number of the excitatory neuronal cell across the layers, wherein the ratio (301) is used to (e.g., randomly) distribute (303) the inhibitory neuronal cell in the layers while ensuring the ratio (301), and wherein the marker genes are markers for the inhibitory neuronal cell.

In an aspect, the ratio (301) of inhibitory to excitatory neuronal cells in the portion of the brain (e.g., in one or more layers of a neocortical column of the brain) may be calculated after applying antibody stains (e.g., DAPI, NeuN or GABA+/−) according to one or more aspects as described in context of FIG. 2. For example, inhibitory and excitatory neuronal cells may be (e.g., randomly) distributed (303) across the portion of the brain (e.g., across the one or more layers of the neocortical column of the brain) while ensuring that the predetermined number of neuronal cells in each layer is compliant with the predetermined ratio for the layer. Exemplary methods to calculate the ratio and the predetermined number of neuronal cells (301) for the portion of the brain (e.g., for each of the one or more layers) are described in context of FIG. 2 and may optionally be combined with one or more of the aspects described in context of FIG. 3.

In an aspect, the constraining further comprises assigning, in a second step (304), e.g., following the first step (303), one or more genetic sequences to the one or more neuronal cells, wherein the one or more sequences include at least one of the one or more marker genes. In an aspect, binary single neuronal cell gene expression of one or more (e.g., seven) marker genes (e.g., neuropeptides such as somatostatin (SOM), vasoactive intestinal peptide (VIP), neuropeptide Y (NPY), parvalbumin (PV), calbindin(CB), cholecystokinin (CCK), or calretinin (CR)), that may be markers for neuronal cells, e g inhibitory neuronal cells, may be obtained from experimental data. For example, this experimental data may be obtained from different morphologically annotated neuronal cells using multiplex RT-PCR data. In principle, there are other ways as well to obtain this data namely sequencing related techniques (single cell genetics) and protein-related techniques (single cell proteomics). For example, single neuronal cell expression data may be obtained for morphologically, electrically or pharmacologically identified cells. A genetic cell type may be defined as a profile of gene expressions. In an aspect, the one or more genetic sequences may be (e.g., randomly) assigned, in the second step (304), to the one or more neuronal cells of the start distribution generated in the first step (303). The second step may be performed in order to ensure that the gene expression of the one or more (e.g., seven) marker genes in the one or more neuronal cells is biologically plausible and that the combinations of co-expressions may not be random.

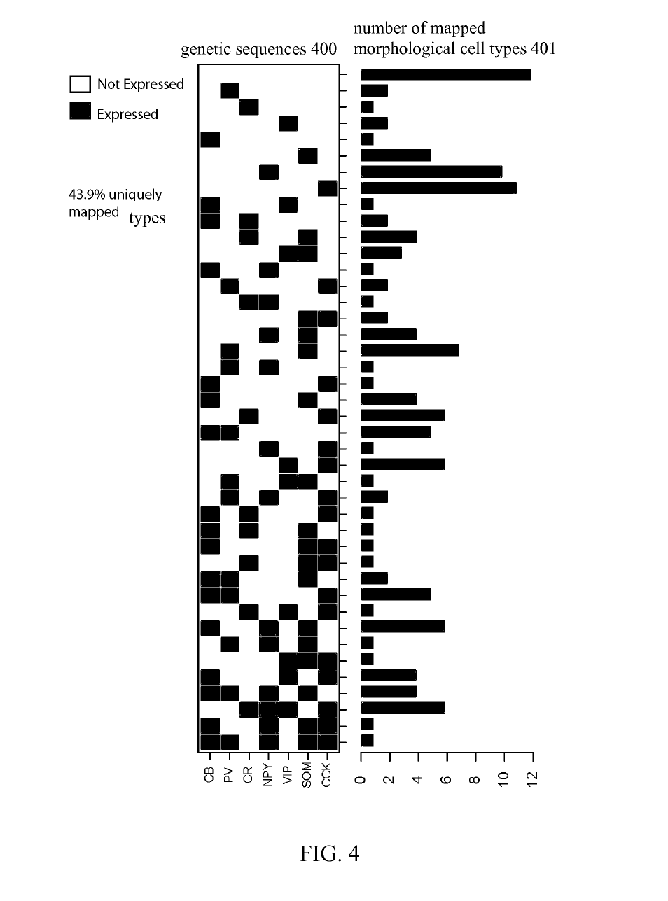

Turning to FIG. 4. FIG. 4 illustrates exemplary genetic sequences (400) with an exemplary number (401) of mapped, in this case, morphological cell types. For example, 42 different genetic sequences (401) may be mapped to 12 different morphological types (BP, BTC, DBC, LBC, MC, NBC, NGC, SBC, ChC, SSC, or PC). For example, out of the 42 genetic sequences (401), 18 (43.9%) may be uniquely mapped to a morphological cell type, which may show that some neuronal cells may be accurately distinguished by their genetic sequence (401). In an aspect, a subset of the one or more genetic sequences (401) includes members (i.e., genetic sequences) that each uniquely map to one of the morphological cell types.

Returning to FIG. 3. In an aspect of the method or model (300), the constraining may comprise comparing, e.g. in a third step (305) following the second step (304), the protein stain of the one or more marker genes across the portion of the brain with the start distribution. In an aspect, the protein (e.g., antibody) stain of the one or more (e.g., seven) marker genes may be obtained in order to compare their distributions in the column with the start distribution generated by method (300) as described in context of FIG. 3. Although the raw stains may correspond to the protein expression of the one or more marker genes and not to their genetic expressions, comparing these two types of distributions may allow ensuring that the one or more marker genes are expressed whenever their protein may be required to be expressed. In an aspect, immunohistochemical stainings of the column may be performed for the protein (e.g., calcium binding protein or antibody). For example, free-floating sections of the column may be treated with 1% H₂O₂ for 30 minutes, for 1 hour with 0.25% Triton-X and 3% horse serum using processing with the avidin-biotin method and the Vectastain ABC immunoperoxidase kit as chromogen. Staining images may be captured with a digital camera attached to a microscope.

The following aspects may provide an exemplary implementation or embodiment of the computer-implemented method of model (300), in particular of the third (305) and/or fourth step (306) of the method or model (300), described in context of FIG. 3. Specifically, how the quantities and/or parameters involved in the model may be computed. One or more of the following aspects or implementations may be combined with the aspects described in FIG. 3. In equations (1) to (4), the term “layer” refers to a geometric subunit of the portion of the brain, e.g. the geometric subunit may be the one or more layers of the neocortical column of the brain in case the portion of the brain is the neocortical column of the brain in an implementation of the model described in this disclosure. In an aspect, a percentage of expressions of each of the one or more (e.g., seven) marker genes in the, e.g. randomly, distributed neuronal cells were then (e.g., simultaneously) compared to that of their corresponding protein (e.g., antibody) stained slice as follows. The percentage of expression of the one or more (e.g., seven) marker genes in, e.g. each of, the one or more (e.g., six) layers of the cortical column (GEP: generated expression percentage) may be calculated as stated in Eq. (1).

$$\begin{matrix}{GEP}_{ij} \frac{number of neurons expressing gene i in layer j}{total number of neurons expressing gene i} & ( 1 ) \\ {PEP}_{ij} = \frac{number of stains of protein i in layer j}{total number of stains of protein i} & ( 2 ) \\ {MarkerError}_{i} = mean ( \vert {GEP}_{ij} - {PEP}_{ij} \vert ) & ( 3 ) \\ Fitness Function Error = {\sum }_{i = 1}^{number of marker genes} {MarkerError}_{i} & ( 4 )\end{matrix}$$

In an aspect, the percentage of expression (PEP: protein expression percentage) of the protein (e.g., antibody) in, e.g. each of, the one or more (e.g., six) layers of the column may be calculated according to Eq. (2). In an aspect, an error of one marker gene i (MarkerError) may be computed as an average of the absolute value of the differences of GEP and PEP in the one or more (e.g., six) layers j of the column as shown in Eq. (3) (summation over layer j in Eq. (3)). In an aspect, a total error of a fitting function (FitnessFunctionError) of a distribution may be calculated as being a sum (over all different marker genes) of the one or more MarkerError as stated in Eq. (4) (e.g., the number of marker genes may be between 1 and 100, optionally between 1 and 10, optionally be about 7). In an aspect, one may have a mutli-obective optimized whereby one may take the sum but keep each of the summand separate and one may not take the average but keep each layer separate.

In an aspect, the method or model (300), e.g. the constraining, may comprise: repeating, in a fourth step (306), the second (304) and the third step (305) a given number of times while computing, for each time of the given number of times, a deviation (e.g. the MarkerError of Eq. (3) and/or the FitnessFunctionError of Eq. (4)) of the expression of the one or more marker genes from the protein stain of the corresponding marker gene, wherein the target distribution is determined using a distribution of the one or more neuronal cells across the portion of the brain that shows the lowest of the computed deviations. For example, the fourth step (306) may be performed following the third step (305). For instance, the lower the deviation, the higher is a fitness of a distribution, e.g. of the target distribution. In an aspect, the target distribution may show a higher fitness in an optimization algorithm compared to the start distribution, wherein the optimization algorithm is at least one of evolutionary algorithm, genetic algorithm, simulated annealing algorithm and swarm optimization algorithm. In an aspect, the fitness may be computed by calculating a difference or the deviation between an expression percentage of each of the marker genes in the portion of the brain (e.g., in each of the one or more layers of the neocortical column of the brain) and an expression percentage of each of the protein in the portion of the brain (e.g., in each of the one or more layers of the neocortical column of the brain). In an aspect, the second (304) and the third step (305) may be rerun a given number (e.g., between 10 and 10000, optionally between 100 and 10000, optionally between 100 and 1000, optionally about 1000 times) of times, which may result in different start distributions of the one or more (e.g., 42) genetic sequences. For example, a certain number (e.g., between 10 and 10000, optionally between 10 and 1000, optionally about 100) individual distributions with the lowest FitnessFunctionError and/or the highest fitness may be retained to form a first generation of distributions and may then be used to populate subsequent generations of distributions with a two-point crossover rate, e.g. of between 0.1 and 1.0, optionally of about 0.9. In an aspect, elitism may also be applied and, e.g., the fittest solution may be retained from one generation to a following generation. In an aspect, about 800 generations using a genetic algorithm may be generated. In other words, the model (300) or optimization algorithm implemented in the third and fourth step of the model (300) may (e.g., randomly) add each genetic sequence to each layer up to an anatomically-determined number of cells, and then iteratively changes the relative densities of the genetic sequences until respective in-silico stainings of each of the genetic markers approximately match (e.g., to within 20%, optionally to within 10%) the in-vitro stainings.

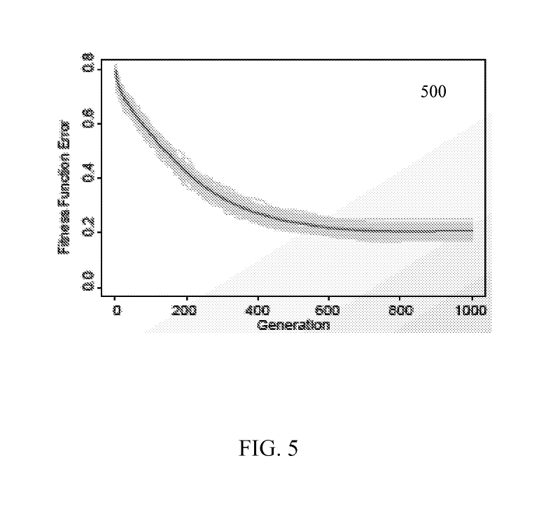

FIG. 5 illustrates an exemplary improvement (500) of the FitnessFunctionError as function of the number of the generation of the distribution that is computed in the fourth step of FIG. 3. For example, the fittest population in the genetic algorithm may be obtained from the start distribution that initially may have a FFE value of between 0.4 and 1, optionally between 0.6 and 0.9, optionally of about 0.8. After running the genetic algorithm, the FFE may drop by more than four folds, e.g. converting towards between 0 and 0.3, optionally between 0.1 and 0.2, optionally to about 0.167 for the fittest distribution (e.g. the target distribution). Convergence of the distributions and/or fitness may be reached, e.g. after about 750 generations. In an aspect, the distribution of the one or more marker genes of the target distribution (e.g., best matched or fittest distribution) and the distribution of the proteins of the stains may be similar (e.g., to within 20%, optionally to within 10%) across the portion of the brain (e.g., across the one or more layers of the neocortical column of the brain).

Returning to FIG. 3. After the fourth step (306) according to one or more aspects described in context of FIG. 3, a distribution of the one or more genetic sequences in the one or more (e.g., six) layers of the column is computed, obtained or determined that best matches (e.g., show the lowest deviation, the lowest FitnessFunctionError, and/or the highest fitness) the (e.g., seven) protein stained slices.

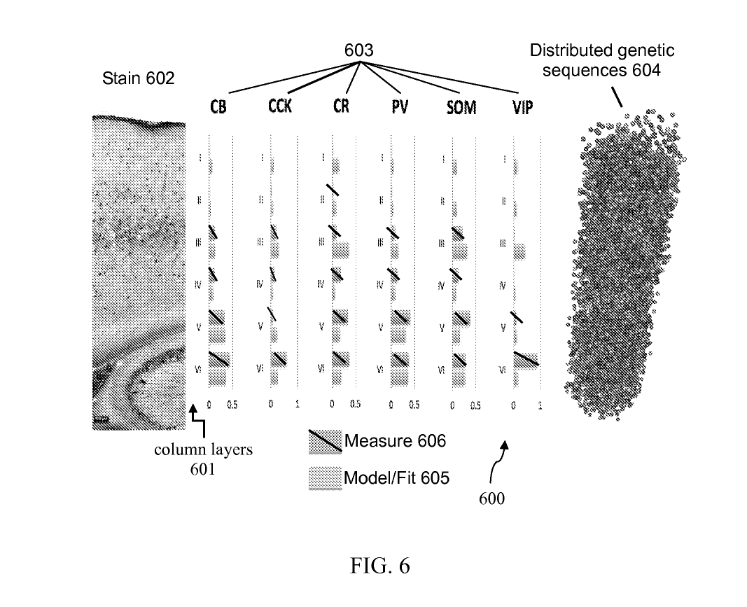

FIG. 6 illustrates an exemplary target distribution (600) of the one or more neuronal cells across the one or more (e.g., between 1 and 10, optionally six) layers (601) of the cortical column, e.g. after the fourth step of the model or method described in context of FIG. 3. FIG. 6 shows a distribution of the genetic sequences (604) that matches (e.g., to within 20%, optionally to within 10%) the protein stains (602) of the one or more (e.g., between 1 and 10, optionally six, optionally seven) marker genes (603), wherein each of the genetic sequences may include at least one of the one or more marker genes (603). In an aspect of the method or model described in context of FIG. 3, the determining of the target distribution may comprise: determining a distribution (604) of the one or more genetic sequences of the one or more neuronal cells across the portion of the brain (e.g., the one or more layers (601) of the neocortical column of the brain) that converges (e.g., to within 20%, optionally to within 10%) towards the protein stain (602) of the one or more marker genes (603) across the portion of the brain (e.g., the one or more layers (601)). FIG. 5 shows comparisons between the target distribution according to the model or fit (605) and the protein stain according to measurements as described in one or more aspects in context of FIG. 2.

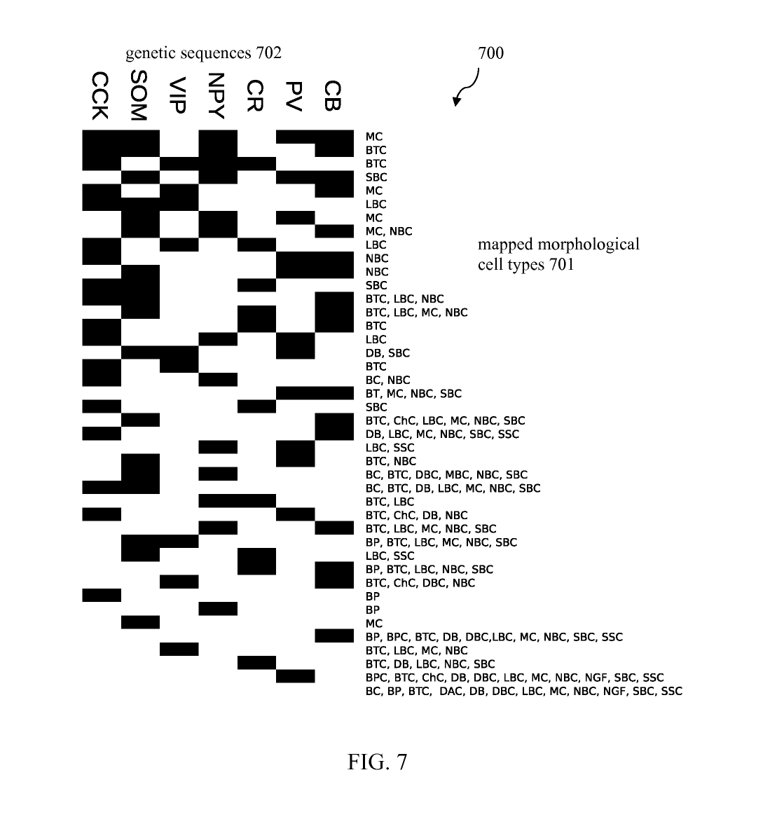

Returning to FIG. 3. In an aspect of the method or model (300) described in context of FIG. 3, the method or model may further comprise: mapping (307) the one or more genetic sequences to the one or more cell types, wherein the target distribution represents a distribution of the one or more cell types across the portion of the brain, and wherein the cell types may be at least one of morphological cell types, electrical cell types and pharmacological cell types In an aspect, each of the one or more genetic sequences may be mapped to its annotated cell type (see, e.g., FIGS. 4, 7).

FIG. 7 illustrates an exemplary mapping (700) of the one or more genetic sequences (702) to the one or more cell types (701), in this case morphological cell types. In an aspect, the genetic sequences are mapped back to the cell types using recorded correspondence to the cell types as shown in FIG. 4. The model described in context of FIG. 3 may provide a derived composition of cell types. Furthermore, this may identify data and conditions that are required for a determination of the most likely distribution of the one or more neuronal cells (e.g., the target distribution) according to their one or more genetic sequences.

Returning to FIG. 3. In an aspect, in case the one or more genetic sequences are mapped (307) to more than one of the cell types, then only one of the types may be selected (e.g., randomly) for the mapping. In an aspect, a proportion of the cell types in the portion of the brain (e.g., the one or more layers, e.g. six layers, of the neocortical column of the brain) may be computed and may be outputted as the target distribution. In an aspect, the method or model (300) may further comprise: outputting (308) the target distribution, wherein the target distribution shows a lower deviation of the expression of the one or more marker genes from the protein stain of the corresponding marker gene than the start distribution. In an aspect, the model may end (309) after the outputting (308). For example, the outputted (308) target distribution may show the highest obtained fitness obtained by the optimization algorithm described above and/or may show the lowest FitnessFunctionError as defined above in Eq. (4).

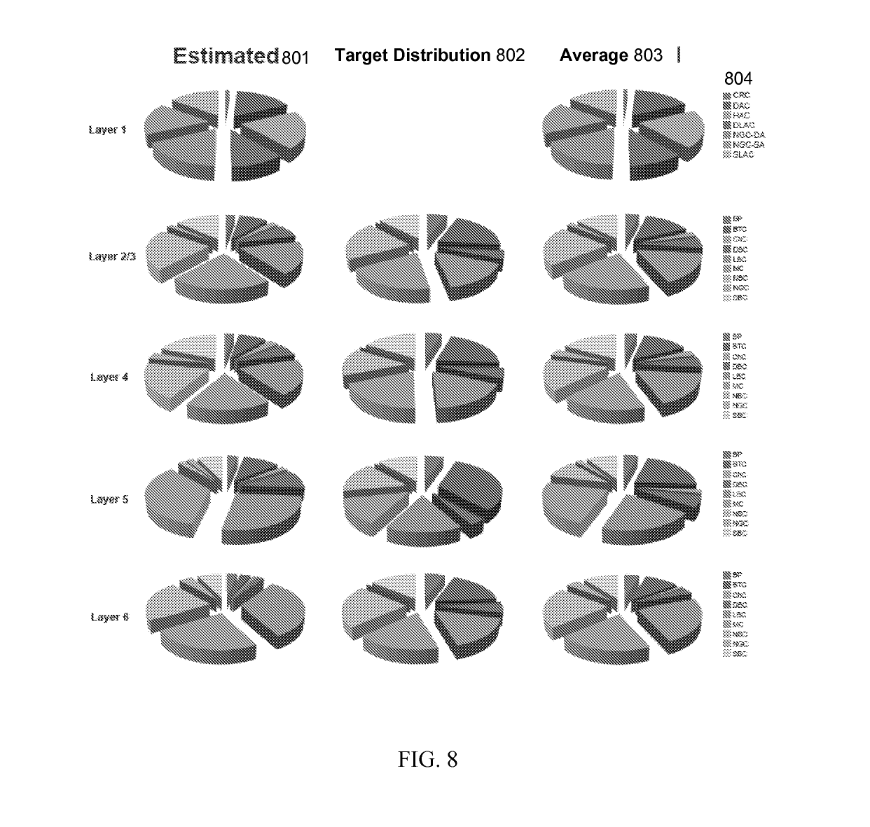

In an aspect, the target distribution is outputted (308) by comparing the target distribution with a given distribution and outputting (308) an average of the target distribution and the given distribution. In an aspect, the target distribution of the one or more neuronal cells may be compared with an estimated distribution (e.g., the given distribution) based on experimental findings and/or literature data. In an aspect, an average proportion of the cell types may be taken to be the average of the target distribution and the estimated proportions according to the estimated distribution. FIG. 8 illustrates exemplary target distributions (802), estimated or given distributions (801), and the average (803) of the two former distributions with respect to the, in this case morphological, cell types (804) across the one or more (e.g., six) layers of the cortical column. In an aspect, profiles of the fittest target solution may be mapped to their corresponding cell types and the proportion of each of the cell types may be computed for the portion of the brain (e.g., for each of the one or more layers of the neocortical column of the brain). For example, if 43.9% of the profiles uniquely map to one of the, e.g. morphological, cell types (as shown in FIGS. 4, 7), the remaining profiles may lead to different proportions since the profiles may be mapped to different cell types. In an aspect, one may (e.g., randomly) select one of the, e.g. morphological, cell types out of the possible cell types and/or apply additional constraints, e.g. provided by future experimental data, on the mapping to the cell type. In an aspect, a correction may be applied by comparing the target distribution obtained, e.g. after the fourth step (306) in FIG. 3 to the estimated distribution, e.g. obtained from literature or experimental data. In an aspect, the average proportion of the target distribution and the estimated distribution may be used as outputted distribution in step (308) in FIG. 3. The outputted distribution may be a first draft of a complete morpho-electrical cell cellular composition of the neocortinal column that may be consistent with molecular properties presently available, while integration of future experimental data is simplified and may further enhance diversity and/or accuracy of the model.

In a general aspect of the model (300) described in context of FIG. 3, a system for determining a target distribution of one or more neuronal cells across a portion of a brain (e.g., across the one or more layers of the neocortical column of the brain) may comprise a processor that is configured to execute the following operations: generating a start distribution of the one or more neuronal cells; constraining the start distribution of the one or more neuronal cells across the portion of the brain by expression of one or more marker genes across the portion of the brain and by protein stain of the one or more marker genes across the portion of the brain to obtain the target distribution, wherein the constraining comprises: assigning one or more genetic sequences to the one or more neuronal cells, wherein the one or more sequences include at least one of the one or more marker genes; and mapping the one or more genetic sequences to one or more cell types, wherein the cell types may be at least one of morphological cell types, electrical cell types and pharmacological cell types; and outputting the target distribution, wherein the target distribution shows a lower deviation of the expression of the one or more marker genes from the protein stain of the corresponding marker gene than the start distribution.

In particular, the term “layer” in this disclosure may refer to a geometric subunit of the neocortical column the brain, e.g. in case the portion of the brain is the neocortical column of the brain in an embodiment of the model described in this disclosure.

At a high level, computer or processor comprises an electronic computing unit (e.g., a processor) operable to receive, transmit, process, store, or manage data and information associated with an operating environment. As used in the present disclosure, the term “computer” or “processor” is intended to encompass any suitable processing device. The term “processor” is to be understood as being a single processor that is configured to perform operations as defined by one or more aspects described in this disclosure, or the “processor” comprises two or more processors, that are configured to perform the same operations, e.g. in a manner that the operations are distributed among the two or more processors. This may allow to process the operations parallel by the two or more processors. The two or more processors may be arranged within a supercomputer, the supercomputer may comprises multiple cores allowing for parallel processing of the operations. For instance, computer or processor may be a desktop or a laptop computer, a cellular phone, a smartphone, a personal digital assistant, a tablet computer, an e-book reader or a mobile player of media. Furthermore, the operating environment can be implemented using any number of servers, as well as computers other than servers, including a server pool. Indeed, the computer or processor and the server may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, the computer, processor and server may be adapted to execute any operating system, including Linux, UNIX, Windows, Mac OS, iOS, Android or any other suitable operating system.

The term “computing device”, “server” or “processor” encompasses all kinds of apparatus, devices, and machines for processing data, including by way of example a programmable processor, a computer, a system on a chip, or multiple ones, or combinations of the foregoing. The apparatus can include special purpose logic circuitry, e.g., an FPGA (field programmable gate array), a CUDA (Compute Unified Device Architecture) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and operating environment can realize various different computing model infrastructures.

Regardless of the particular implementation, “software” may include computer-readable instructions, firmware, wired or programmed hardware, or any combination thereof on a tangible and non-transitory medium operable when executed to perform at least the processes and operations described herein. Indeed, each software component may be fully or partially written or described in any appropriate computer language including C, C++, Java, Visual Basic, assembler, Python and R, Perl, any suitable version of 4GL, as well as others.

The figures and accompanying description illustrate example processes and computer-implementable techniques. However, operating environment (or its software or hardware components) contemplates using, implementing, or executing any suitable technique for performing these and other processes. It will be understood that these processes are for illustration purposes only and that the described or similar techniques may be performed at any appropriate time, including concurrently, individually, or in combination. In addition, many of the steps in these processes may take place simultaneously, concurrently, and/or in different orders or combinations than shown. Moreover, operating environment may use processes with additional steps, fewer steps, and/or different steps, so long as the methods remain appropriate.

Aspects of the subject-matter and the operations described in this specification can be implemented in digital electronic circuitry, neuromorphic circuits, analog circuits, or in computer software, firmware, or hardware, including the structures disclosed in this specification and their structural equivalents, or in combinations of one or more of them. Embodiments of the subject-matter described in this specification can be implemented as one or more computer programs, i.e., one or more modules of computer program instructions, encoded on computer storage medium for execution by, or to control the operation of a data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices). The operations described in this specification can be implemented as operations performed by a data processing apparatus on data stored on one or more computer-readable storage devices or received from other sources.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer or computer or processor may be a processor for performing actions in accordance with instructions and one or more memory devices for storing instructions and data. Generally, a computer or computer or processor will also include, or be operatively coupled to receive data from or transfer data to, or both, one or more mass storage devices for storing data, e.g., magnetic, magneto-optical disks, or optical disks. However, a computer or computing device need not have such devices. Moreover, a computer or computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject-matter described in this specification can be implemented on a computer having a non-flexible or flexible screen, e.g., a CRT (cathode ray tube), LCD (liquid crystal display) or OLED (organic light emitting diode) monitor, for displaying information to the user and a keyboard and a pointer, e.g., a finger, a stylus, a mouse or a trackball, by which the user can provide input to the computer. Other kinds of devices can be used to provide for interaction with a user as well; for example, feedback provided to the user can be any form of sensory feedback, e.g., touch feedback, visual feedback, auditory feedback, or tactile feedback; and input from the user can be received in any form, including acoustic, speech, touch or tactile input. In addition, a computer or computer or processor can interact with a user by sending documents to and receiving documents from a device that is used by the user; for example, by sending web pages to a web browser on a user's user device in response to requests received from the web browser.

Embodiments of the subject-matter described in this specification can be implemented in a computing system that includes a back-end component, e.g., as a server, or that includes a middleware component, e.g., an application server, or that includes a front-end component, e.g., a user computer having a graphical user interface or a Web browser through which a user can interact with an implementation of the subject-matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the operations recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method for determining a target distribution of one or more neuronal cells across a portion of a brain, comprising:
constraining, by one or more computers, a start distribution of the one or more neuronal cells by expression of one or more marker genes and by protein stain of the one or more marker genes across the portion of the brain to obtain the target distribution.

2. The method of claim 1, further comprising:
outputting the target distribution, wherein the target distribution shows a lower deviation of the expression of the one or more marker genes from the protein stain of the corresponding marker gene than the start distribution.

3. The method of claim 2, wherein the constraining comprises:
generating, in a first step, the start distribution of the one or more neuronal cells based on a predetermined number of neuronal cells for the portion of the brain.

4. The method of claim 3, wherein the constraining comprises:
assigning, in a second step following the first step, one or more genetic sequences to the one or more neuronal cells, wherein at least one of the one or more sequences includes at least one of the one or more marker genes.

5. The method of claim 4, wherein the constraining comprises:
comparing, in a third step following the second step, the protein stain of the one or more marker genes across the portion of the brain with the start distribution.

6. The method of claim 5, wherein the constraining comprises:
repeating, in a fourth step, the second and the third step a given number of times while computing, for each time of the given number of times, the deviation, wherein the target distribution is determined using a distribution of the one or more neuronal cells across the portion of the brain that shows the lowest of the computed deviations.

7. The method of claim 6, wherein the constraining comprises:
mapping the one or more genetic sequences to one or more cell types, wherein the target distribution represents a distribution of the one or more morphological cell types across the portion of the brain, and wherein the cell types are at least one of morphological cell types, electrical cell types and pharmacological cell types.

8. A system for determining a target distribution of one or more neuronal cells across a portion of a brain, comprising a processor that is configured to execute the following operations:
constraining a start distribution of the one or more neuronal cells by expression of one or more marker genes and by protein stain of the one or more marker genes across the portion of the brain to obtain the target distribution.

9. The system of claim 8, wherein the processor is further configured to execute the following operations:
outputting the target distribution, wherein the target distribution shows a lower deviation of the expression of the one or more marker genes from the protein stain of the corresponding marker gene than the start distribution.

10. The system of claim 9, wherein the constraining comprises:
generating, in a first step, the start distribution of the one or more neuronal cells based on a predetermined number of neuronal cells for the portion of the brain.

11. The system of claim 10, wherein the constraining comprises:
assigning, in a second step following the first step, one or more genetic sequences to the one or more neuronal cells, wherein at least one of the one or more sequences include at least one of the one or more marker genes.

12. The system of claim 11, wherein the constraining comprises:
comparing, in a third step following the second step, the protein stain of the one or more marker genes across the portion of the brain with the start distribution.

13. The system of claim 12, wherein the constraining comprises:
repeating, in a fourth step, the second and the third step a given number of times while computing, for each time of the given number of times, the deviation, wherein the target distribution is determined using a distribution of the one or more neuronal cells across the portion of the brain that shows the lowest of the computed deviations.

14. The system of claim 13, wherein the constraining comprises:
mapping the one or more genetic sequences to one or more cell types, wherein the target distribution represents a distribution of the one or more morphological cell types across the portion of the brain, and wherein the cell types are at least one of morphological cell types, electrical cell types and pharmacological cell types.

15. A computer-readable medium having computer-executable instructions stored thereon that, when executed by a processor, cause the processor to perform a method for determining a target distribution of one or more neuronal cells across a portion of a brain, comprising:
constraining a start distribution of the one or more neuronal cells by expression of one or more marker genes and by protein stain of the one or more marker genes across the portion of the brain to obtain the target distribution.

16. The computer-readable medium of claim 15, wherein the method is further comprising:
outputting the target distribution, wherein the target distribution shows a lower deviation of the expression of the one or more marker genes from the protein stain of the corresponding marker gene than the start distribution.

17. The computer-readable medium of claim 16, wherein the constraining comprises:
generating, in a first step, the start distribution of the one or more neuronal cells based on a predetermined number of neuronal cells for the portion of the brain.

18. The computer-readable medium of claim 17, wherein the constraining comprises:
assigning, in a second step following the first step, one or more genetic sequences to the one or more neuronal cells, wherein at least one of the one or more sequences includes at least one of the one or more marker genes.

19. The computer-readable medium of claim 18, wherein the constraining comprises:
comparing, in a third step following the second step, the protein stain of the one or more marker genes across the portion of the brain with the start distribution.

20. The computer-readable medium of claim 19, wherein the constraining comprises:
repeating, in a fourth step, the second and the third step a given number of times while computing, for each time of the given number of times, the deviation, wherein the target distribution is determined using a distribution of the one or more neuronal cells across the portion of the brain that shows the lowest of the computed deviations.

21. The computer-readable medium of claim 20, wherein the constraining comprises:
mapping the one or more genetic sequences to one or more cell types, wherein the target distribution represents a distribution of the one or more cell types across the portion of the brain, and wherein the cell types are at least one of morphological cell types, electrical cell types and pharmacological cell types.

22. A system for determining a target distribution of one or more neuronal cells across a portion of a brain, comprising a processor that is configured to execute the following operations:
generating a start distribution of the one or more neuronal cells;
constraining a start distribution of the one or more neuronal cells by expression of one or more marker genes and by protein stain of the one or more marker genes across the portion of the brain to obtain the target distribution, wherein the constraining comprises:
assigning one or more genetic sequences to the one or more neuronal cells, wherein at least one of the one or more sequences includes at least one of the one or more marker genes; and
mapping the one or more genetic sequences to one or more cell types, wherein the cell types are at least one of morphological cell types, electrical cell types and pharmacological cell types; and
outputting the target distribution, wherein the target distribution shows a lower deviation of the expression of the one or more marker genes from the protein stain of the corresponding marker gene than the start distribution.
